(19) United States
(12) Patent Application Publication
(10) Pub. No.: US 2026/0100191 A1
(43) Pub. Date: Apr. 9, 2026

(54) RESPONSE SYSTEM AND RESPONSE METHOD

(71) Applicant: HONDA MOTOR CO., LTD., Tokyo (JP)

(72) Inventor: Shinichi Kikuchi, Tokyo (JP)

(21) Appl. No.: 19/339,581

(22) Filed: Sep. 25, 2025

(30) Foreign Application Priority Data
Oct. 7, 2024 (JP) 2024-175717

(51) Int. Cl. G10L 15/22

(52) U.S. Cl. CPC G10L 15/22; G10L 2015/228

(57) ABSTRACT

A response system includes: a content reproduction unit that reproduces a content; a microphone; an input voice recognition unit that recognizes an input voice to the microphone; and a response generation unit that generates a response sentence to the input voice based on the input voice and the content which is reproduced by the content reproduction unit before an input time point of the input voice to the microphone.

### INCORPORATION BY REFERENCE

The present application claims priority under 35 U.S.C. § 119 to Japanese Patent Application No. 2024-175717 filed on Oct. 7, 2024. The content of the application is incorporated herein by reference in its entirety.

### BACKGROUND OF THE INVENTION

### Field of the Invention

The present invention relates to a response system and a response method.

### Description of the Related Art

By evolution and so forth of learning models using machine learning in recent years, a technique has been realized in which an appropriate response is performed to an input using a natural language. For example, International Publication No. WO 2022/050060 discloses a technique which increases a correct answer probability of an answer to a question query configured with a text in a natural language.

### SUMMARY OF THE INVENTION

In recent years, by evolution and so forth of voice recognition engines, a technique has been developed in which a voice uttered by a person is used as an input using a natural language. Such a technique has been applied to a response system or the like which outputs, by a voice, characters, or the like, a sentence as a response to contents spoken by a person and thereby performs conversation with a person. However, a response system in related art has not been capable of a response in consideration of background information such as a content viewed by a person, and there has been room for improvement for performing a more natural response.

The present invention has been made in consideration of the above-described circumstance, and an object thereof is to enable a natural response to an input voice.

One aspect of the present invention provides a response system including: a content reproduction unit that reproduces a content; a microphone; an input voice recognition unit that recognizes an input voice to the microphone; and a response generation unit that generates a response sentence to the input voice based on the input voice and the content which is reproduced by the content reproduction unit before an input time point of the input voice to the microphone.

Another aspect of the present invention provides a response method including: reproducing a content by a content reproduction unit; recognizing an input voice to a microphone by an input voice recognition unit; and generating, by a response generation unit, a response sentence to the input voice based on the input voice and the content which is reproduced by the content reproduction unit before an input time point of the input voice to the microphone.

In a response system according to one aspect of the present invention and a response method according to another aspect, a response sentence to an input voice can be generated while a content reproduced by a content reproduction unit is taken into consideration. Thus, a natural response can be performed to the input voice.

### BRIEF DESCRIPTION OF THE DRAWINGS

FIG. 1 is a diagram illustrating a configuration of a response system according to a first embodiment;

FIG. 2 is a diagram illustrating configurations of a response device and a response generation server;

FIG. 3 is a flowchart illustrating actions of the response device and the response generation server;

FIG. 4 is a flowchart illustrating an action of a response generation unit; and

FIG. 5 is a flowchart illustrating the action of the response generation unit.

### DETAILED DESCRIPTION OF THE PREFERRED EMBODIMENTS

### 1. First Embodiment

First, a first embodiment will be described with reference to the drawings.

### 1-1. General Configuration of Response System

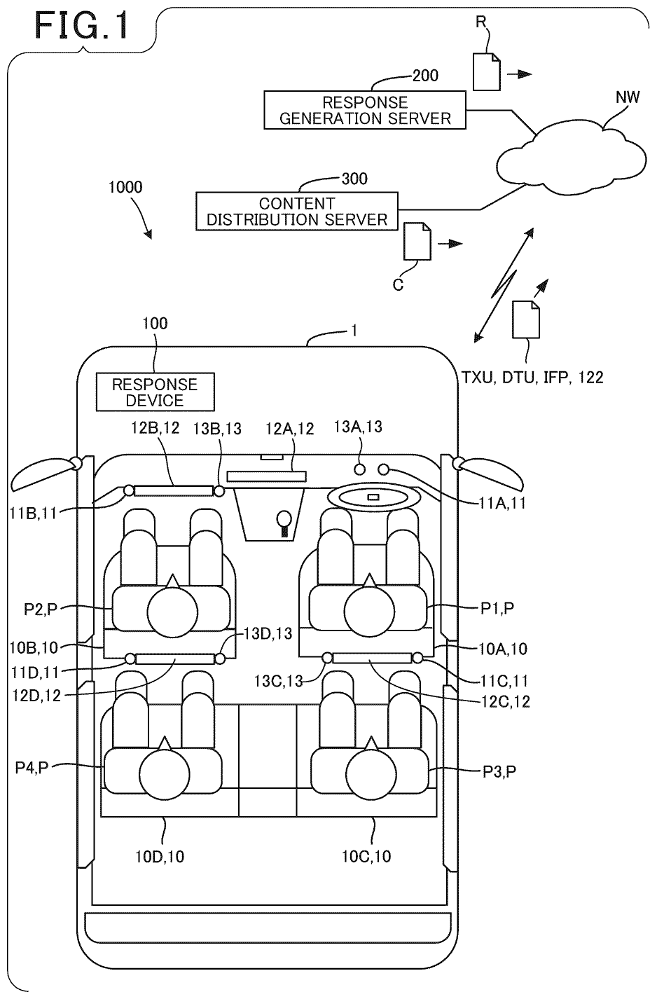

FIG. 1 is a diagram illustrating a configuration of a response system 1000 according to the first embodiment.

The response system 1000 is a system which outputs a response sentence R to a sentence included in an input voice while taking into consideration contents of a content C reproduced in a vehicle 1. The response sentence R to be output by the response system 1000 can be a sentence which represents any response such as an answer, agreement, or a denial to contents of the input voice. The response sentence R to be output by the response system 1000 can be output by any form such as display of characters or a voice.

As illustrated in FIG. 1, the response system 1000 includes the vehicle 1, a response generation server 200, and a content distribution server 300. Note that in the response system 1000, it is possible to freely set the numbers of vehicles 1, response generation servers 200, and content distribution servers 300.

The response generation server 200 is a server device that generates the response sentence R that a response device 100 outputs by using a display 12 or a speaker 13. The response generation server 200 is connected to a communication network NW and communicates with the vehicle 1.

The content distribution server 300 is a server device which distributes the content C. The content distribution server 300 is connected to the communication network NW and communicates with the vehicle 1. Note that the communication network NW is configured with a public line network, a dedicated line, other communication circuits, and so forth. The response system 1000 may include the content distribution server 300 for each content distribution source. The content distribution server 300 may be a server device that distributes contents C while integrating the contents C which are distributed by a plurality of content distribution sources.

The content C to be distributed to the vehicle 1 by the content distribution server 300 includes a sentence in a form of a voice or characters. The sentence included in the content C will hereinafter be referred to as a content sentence TXC. The content sentence TXC can be configured with one or more sentences. In the present embodiment, each content sentence TXC is configured with one sentence. The content C can include one or more content sentences TXC.

The content C can be a video content such as a movie or a video program or a voice content such as a voice program, for example. The content sentence TXC can be a voice spoken by a performer in a video content or a voice content and a sentence such as a telop or a subtitle which is displayed in a video content, for example. Note that the content C to be reproduced in the vehicle 1 is not limited to the content C which is distributed from the content distribution server 300. For example, the content C may be broadcasted by radio broadcasting or a television broadcasting or may be the content C read from a storage medium brought into the vehicle 1.

The vehicle 1 illustrated as an example in FIG. 1 is a four-wheeled vehicle. The vehicle 1 includes a driver seat 10A, a passenger seat 10B, a rear right seat 10C, and a rear left seat 10D as seats on which occupants P are seated. The vehicle 1 in FIG. 1 illustrates a situation where an occupant P1 as a driver is seated on the driver seat 10A. The vehicle 1 in FIG. 1 illustrates a situation where an occupant P2 as a fellow passenger is seated on the passenger seat 10B. The vehicle 1 in FIG. 1 illustrates a situation where an occupant P3 as a fellow passenger is seated on the rear right seat 10C. The vehicle 1 in FIG. 1 illustrates a situation where an occupant P4 as a fellow passenger is seated on the rear left seat 10D.

The vehicle 1 includes the response device 100. The response device 100 is configured to be capable of acquiring an input voice as voice data by a microphone 11 provided in the vehicle 1. The response device 100 is configured to be capable of outputting the response sentence R as characters or a voice by at least either one of the display 12 and the speaker 13 which is provided in the vehicle 1.

The microphone 11 is a device which accepts an input of a voice. In the present embodiment, in the vehicle 1, as microphones 11, a driver seat microphone 11A, a passenger seat microphone 11B, a rear right seat microphone 11C, and a rear left seat microphone 11D are provided. The driver seat microphone 11A mainly records a voice spoken by the occupant P1 seated on the driver seat 10A. The passenger seat microphone 11B mainly records a voice spoken by the occupant P2 seated on the passenger seat 10B. The rear right seat microphone 11C mainly records a voice spoken by the occupant P3 seated on the rear right seat 10C. The rear left seat microphone 11D mainly records a voice spoken by the occupant P4 seated on the rear left seat 10D. That is, in the present embodiment, the response device 100 can record respective voices which are spoken by the occupants P1 to P4 seated on the seats 10A to 10D while distinguishing the occupants P1 to P4 who speak. Each of the driver seat microphone 11A, the passenger seat microphone 11B, the rear right seat microphone 11C, and the rear left seat microphone 11D corresponds to a microphone of the present disclosure.

The display 12 is a device which outputs characters or an image. In the present embodiment, in the vehicle 1, as displays 12, a center display 12A, a passenger seat display 12B, a rear right seat display 12C, and a rear left seat display 12D are provided. The center display 12A mainly performs display of characters or an image for the occupant P1 seated on the driver seat 10A. The passenger seat display 12B mainly performs display of characters or an image for the occupant P2 seated on the passenger seat 10B. The rear right seat display 12C mainly performs display of characters or an image for the occupant P3 seated on the rear right seat 10C. The rear left seat display 12D mainly performs display of characters or an image for the occupant P4 seated on the rear left seat 10D. That is, in the present embodiment, the response device 100 is configured to be capable of performing display of characters or an image for all or a freely selected part of the respective occupants P1 to P4 seated on the seats 10A to 10D. Each of the displays 12, 12A to 12D corresponds to a content reproduction unit of the present disclosure.

The speaker 13 is a device which outputs a voice. In the present embodiment, in the vehicle 1, as speakers 13, a center speaker 13A, a passenger seat speaker 13B, a rear right seat speaker 13C, and a rear left seat speaker 13D are provided. The center speaker 13A mainly outputs a voice for the occupant P1 seated on the driver seat 10A. The passenger seat speaker 13B mainly outputs a voice for the occupant P2 seated on the passenger seat 10B. The rear right seat speaker 13C mainly outputs a voice for the occupant P3 seated on the rear right seat 10C. The rear left seat speaker 13D mainly outputs a voice for the occupant P4 seated on the rear left seat 10D. That is, in the present embodiment, the response device 100 is configured to be capable of outputting a voice for all or a freely selected part of the respective occupants P1 to P4 seated on the seats 10A to 10D. Each of the speakers 13, 13A to 13D corresponds to the content reproduction unit of the present disclosure.

### 1-2. Configuration of Response Device

Next, a configuration of the response device 100 will be described.

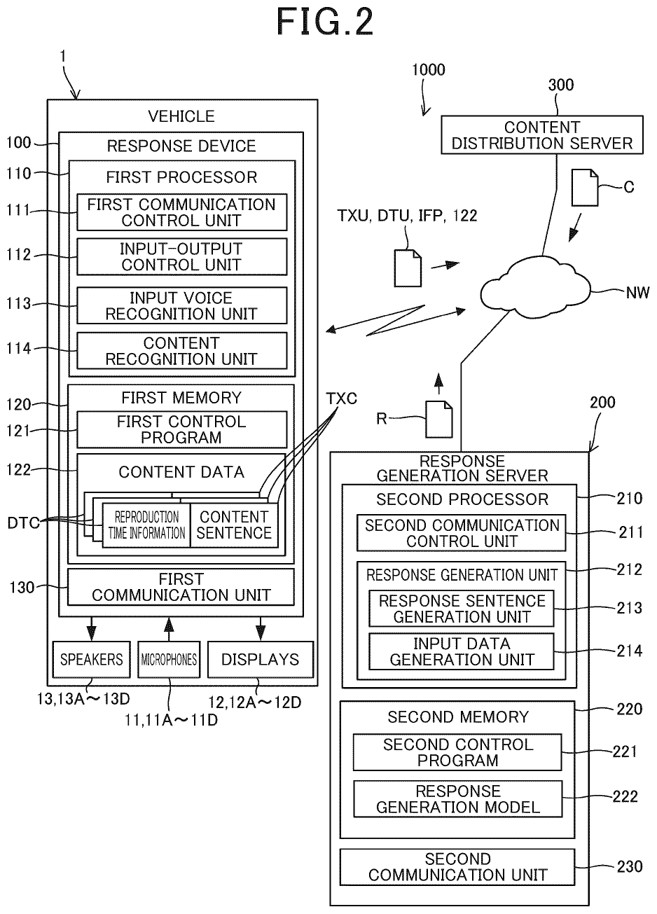

FIG. 2 is a diagram illustrating configurations of the response device 100 and a response generation server 200.

The response device 100 is connected to the microphones 11A to 11D, the displays 12A to 12D, and the speakers 13A to 13D, which are provided in the vehicle 1. Note that devices to be connected to the response device 100 are not limited to those devices, and other kinds of devices may be connected thereto. The response device 100 may include the microphones 11, the displays 12, the speakers 13, or other kinds of devices.

The response device 100 is a control unit which includes a first processor 110, a first memory 120, and a first communication unit 130. The first processor 110 includes a processor such as a central processing unit (CPU) or a microprocessor unit (MPU). The first memory 120 is a storage device which stores programs and data and includes a read-only memory (ROM) or a random-access memory (RAM), for example. The first communication unit 130 includes hardware which conforms to predetermined communication standards of wireless communication circuits and so forth. The response device 100 performs, by the first communication unit 130, communication with the response generation server 200 and the content distribution server 300 via the communication network NW.

The first memory 120 stores a first control program 121 as a program for controlling the response device 100. The first processor 110 reads and executes the first control program 121 and thereby functions as a first communication control unit 111, an input-output control unit 112, an input voice recognition unit 113, and a content recognition unit 114.

The first communication control unit 111 performs, by the first communication unit 130, communication with the response generation server 200 and the content distribution server 300 via the communication network NW.

The input-output control unit 112 uses the microphone 11 as an input device and thereby acquires an input voice as the voice data. In the present embodiment, the input-output control unit 112 acquires an input voice recorded by each of the microphones 11A to 11D while identifying which of the microphones 11A to 11D has recorded the input voice. The input-output control unit 112 uses any device of the display 12 and the speaker 13 as output devices and thereby outputs a response sentence that the first communication control unit 111 receives from the response generation server 200. The input-output control unit 112 uses any device of the display 12 and the speaker 13 as the output devices and thereby outputs the content C in a form of a voice, a video, or the like, the content C being received from the content distribution server 300 by the first communication control unit 111.

The input voice recognition unit 113 recognizes an input voice to each of the microphones 11, 11A to 11D. In detail, the input voice recognition unit 113 converts a sentence included in the input voice as the voice data acquired by the input-output control unit 112 into text data by voice recognition. The sentence included in the input voice is a sentence which is spoken by any one of the occupants P1 to P4. In the following, the sentence included in the input voice will be referred to as a spoken sentence TXU. The spoken sentence TXU which has been converted into the text data is transmitted to the response generation server 200 and is used for generation of the response sentence R.

The input voice to be input to each of the microphones 11, 11A to 11D can be one or more input voices. Each of the input voices can include one or more spoken sentences TXU. Each of the spoken sentences TXU can include one or more sentences. In the present embodiment, the input voice includes one spoken sentence TXU. In the present embodiment, one spoken sentence TXU is configured with one sentence.

In the present embodiment, the input voice recognition unit 113 generates speaking time information DTU and speaking person information IFP accompanying the spoken sentence TXU. The speaking time information DTU is information which indicates time when the spoken sentence TXU included in the input voice is spoken and input to the microphone 11, that is, speaking time.

The speaking person information IFP is information by which the occupant P speaking the spoken sentence TXU can be specified from the occupants P1 to P4. For example, the input voice recognition unit 113 specifies which of the microphones 11A to 11D is used to record the spoken sentence TXU, thereby estimates that the occupant P to be a main recording target of the specified microphone 11 among the microphones 11A to 11D performs speech, and may thereby generate the speaking person information IFP. The input voice recognition unit 113 analyzes a voiceprint of the spoken sentence TXU included in the input voice and may thereby generates the speaking person information IFP.

The content recognition unit 114 converts the content sentence TXC included in the content C in the vehicle 1 into text data. The content sentence TXC which has been converted into the text data is transmitted to the response generation server 200 and is used for generation of the response sentence R.

For example, in a case where the content C is a video content or a voice content, the content recognition unit 114 applies voice recognition to the content sentence TXC as voice data included in the content C and thereby converts the content sentence TXC into the text data. For example, in a case where the content C is a video content, the content recognition unit 114 may acquire the content sentence TXC of text data which are added as subtitles to the content C. The content recognition unit 114 may be configured to apply image recognition or the like to the content sentence TXC which is included, as subtitles, a telop, or the like, in image data of the content C and to thereby convert the content sentence TXC into the text data.

The content recognition unit 114 generates reproduction time information DTC. The reproduction time information DTC is information about time when the content sentence TXC is reproduced in the content C.

Note that the content recognition unit 114 may be configured such that even in a case where the content C to be reproduced in the vehicle 1 is reproduced not via the response device 100, the content recognition unit 114 can convert the content sentence TXC into the text data. For example, the content recognition unit 114 may acquire the voice data about the content C, which is a video content or voice content reproduced in the vehicle 1, via the input-output control unit 112 and the microphone 11. The content recognition unit 114 applies voice recognition to the content sentence TXC included in the acquired voice data and may thereby convert the content sentence TXC into the text data.

The first memory 120 stores content data 122. The content data 122 are a table which has a record including the content sentence TXC as the text data generated by the content recognition unit 114 and the reproduction time information DTC. The content data 122 are updated so as to include, as the record, a pair of the generated content sentence TXC and reproduction time information DTC at each time when the content recognition unit 114 generates the content sentence TXC and the reproduction time information DTC.

### 1-3. Configuration of Response Generation Server

Next, a configuration of the response generation server 200 will be described.

The response generation server 200 is a control unit which includes a second processor 210, a second memory 220, and a second communication unit 230. The second processor 210 includes a processor such as a CPU or an MPU. The second memory 220 is a storage device which stores programs and data and includes a ROM or a RAM, for example. The second communication unit 230 includes hardware which conforms to predetermined communication standards of wireless communication circuits and so forth. The response generation server 200 performs, by the second communication unit 230, communication with the response device 100 via the communication network NW.

The second memory 220 stores a second control program 221 as a program for controlling the response generation server 200. The second processor 210 reads and executes the second control program 221 and thereby functions as a second communication control unit 211 and a response generation unit 212.

The second communication control unit 211 performs, by the second communication unit 230, communication with the response device 100 via the communication network NW.

The response generation unit 212 uses the spoken sentence TXU and the content sentence TXC, which are received from the response device 100 by the second communication unit 230, and thereby generates the response sentence R for the spoken sentence TXU spoken by the occupant P. In detail, the response generation unit 212 further functions as a response sentence generation unit 213 and an input data generation unit 214.

The response sentence generation unit 213 inputs input data to a response generation model 222 stored in the second memory 220 and causes to generate a response sentence. The response generation model 222 is a model which uses, as input data, the spoken sentence TXU as the text data or the spoken sentence TXU and content sentence TXC as the text data and thereby outputs the response sentence R to the spoken sentence TXU. Note that the second memory 220 may store, as the response generation models 222, both of a model which generates the response sentence using only the spoken sentence TXU as the input data and a model which uses the spoken sentence TXU and the content sentence TXC as the input data. The response generation model 222 is a learned model which uses machine learning, for example.

The input data generation unit 214 uses the spoken sentence TXU and the content sentence TXC, which are received from the response device 100, and thereby generates the input data to be input to the response generation model 222. Details of an action of the input data generation unit 214 will be described later.

### 1-4. Outline of Action of Response System

Next, an action of the response system 1000 will be described. In the following, an outline of an action of the response system 1000 will first be described.

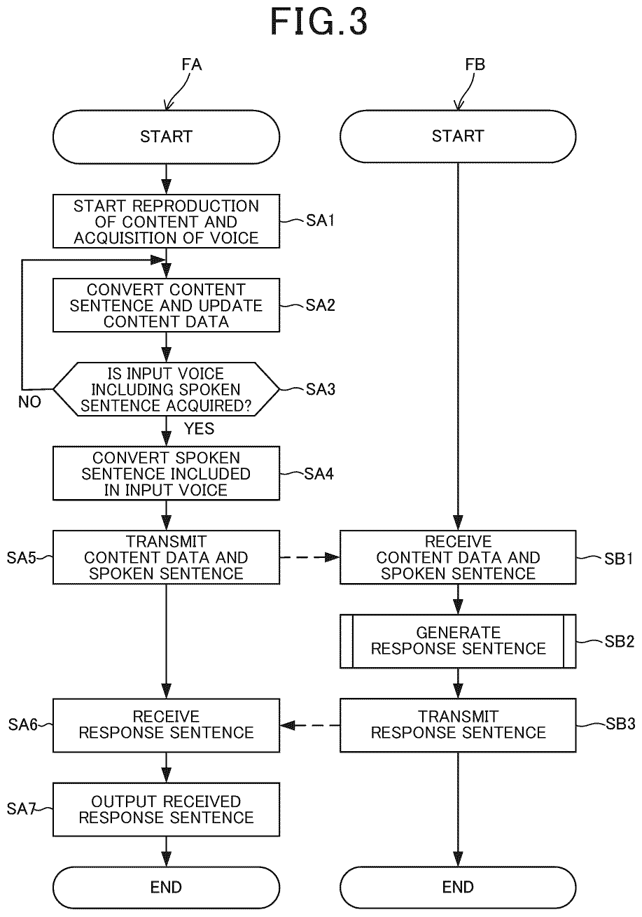

FIG. 3 is a flowchart illustrating actions of the response device 100 and the response generation server 200 and illustrates an action in which the response device 100 outputs the response sentence R for speech of a person. In FIG. 3, a flowchart FA illustrates the action of the response device 100, and a flowchart FB illustrates the action of the response generation server 200. The actions in FIG. 3 are started with turning on of a power source of the response device 100 by an operation or the like by the occupant P being a trigger, for example.

In the beginning, in step SA1, the input-output control unit 112 of the response device 100 starts reproduction of the content C received by the first communication control unit 111. In this case, the input-output control unit 112 starts acquisition of a voice via the microphone 11.

Next, in step SA2, the content recognition unit 114 converts the content sentence TXC of the content C reproduced in the vehicle 1 into the text data. In this case, the content recognition unit 114 generates the reproduction time information DTC corresponding to the converted content sentence TXC. At each time when the content sentence TXC as the text data and the reproduction time information DTC are generated, the content recognition unit 114 adds the pair of generated content sentence TXC and reproduction time information DTC to the content data 122. Accordingly, the content recognition unit 114 updates the content data 122.

In the present embodiment, the content recognition unit 114 is configured to delete, from the content data 122, the record which includes the reproduction time information DTC corresponding to a past time point relative to a time point earlier by a predetermined time period than a present time. The predetermined time period is one minute, for example.

Note that the content recognition unit 114 may be configured to delete the records starting from the older records when the content data 122 are updated such that the number of records of the content data 122 does not exceed a predetermined number. The predetermined number is ten, for example.

Next, in step SA3, the input voice recognition unit 113 determines whether or not the input-output control unit 112 acquires the input voice including the spoken sentence TXU via the microphone 11.

In step SA3, in a case where the input voice recognition unit 113 determines that the input-output control unit 112 does not acquire the input voice including the spoken sentence TXU (NO in step SA3), the action of the response device 100 returns to step SA2.

In step SA3, in a case where the input voice recognition unit 113 determines that the input-output control unit 112 acquires the input voice including the spoken sentence TXU (YES in step SA3), the action of the response device 100 moves to step SA4.

In step SA4, the input voice recognition unit 113 converts the spoken sentence TXU of the input voice acquired by the input-output control unit 112 into the text data. The input voice recognition unit 113 generates the speaking time information DTU and the speaking person information IFP accompanying generation of the spoken sentence TXU as the text data. The numbers of pieces of speaking time information DTU and speaking person information IFP are the same as the number of spoken sentences TXU as the text data to be generated.

Next, in step SA5, the first communication control unit 111 transmits the spoken sentence TXU, which has been converted in step SA4, and the content data 122, which are stored in the first memory 120, to the response generation server 200. In this case, the first communication control unit 111 transmits both of the speaking time information DTU and the speaking person information IFP to the response generation server 200 while associating the speaking time information DTU and the speaking person information IFP with each of the spoken sentence TXU.

Next, in step SB1, the second communication control unit 211 of the response generation server 200 receives the spoken sentence TXU, the speaking time information DTU, the speaking person information IFP, and the content data 122, which are transmitted.

Next, in step SB2, the response generation unit 212 generates the response sentence R based on the received spoken sentence TXU and content data 122. In the present embodiment, in step SB2, output destination information is generated which specifies to which of the occupants P1 to P4 the response sentence R is output. The output destination information is information which specifies one speaker 13, from which the response sentence R is output, among the speakers 13A to 13D or information which specifies one display 12, from which the response sentence R is output, among the displays 12A to 12D, or the like, for example. The output destination information is generated based on the speaking person information IFP corresponding to the spoken sentence TXU as a target of a response by the response sentence R. For example, the output destination information may be information for setting an output destination of the response sentence R to the occupant P who speaks the spoken sentence TXU indicated by the speaking person information IFP. Details about step SB2 will be described later.

Next, in step SB3, the second communication control unit 211 transmits the generated response sentence R to the response device 100. In this case, together with that, the second communication control unit 211 transmits the output destination information.

Next, in step SA6, the first communication control unit 111 of the response device 100 receives the transmitted response sentence R and output destination information.

Next, in step SA7, the input-output control unit 112 outputs the response sentence R received by the first communication control unit 111 from any output device such as the display 12 or the speaker 13. In the present embodiment, in step SA7, the input-output control unit 112 outputs the response sentence R as a voice by using the speaker 13. By execution of step SA7, a response by an appropriate response sentence R is performed to the spoken sentence TXU spoken by the occupant P, and the actions in FIG. 3 are finished.

In the present embodiment, the input-output control unit 112 can refer to the received output destination information and can thereby output the response sentence R to one or more targets which are specified from the occupants P1 to P4 by the output destination information. For example, the input-output control unit 112 refers to the output destination information, outputs the response sentence R by using the speaker 13A or display 12A, and can thereby output the response sentence R to the occupant P1.

As described later, in a case where a plurality of response sentences R are generated for the spoken sentences TXU of a plurality of occupants P in step SB2, in step SA7, the input-output control unit 112 may change order of outputs of the response sentences R in accordance with the output destination information. For example, when the response sentence R is generated for each of the all occupants P1 to P4, the input-output control unit 112 refers to the output destination information of each of the response sentences R and may thereby output the response sentences R in order of the occupants P seated on the driver seat 10A, the passenger seat 10B, the rear right seat 10C, and the rear left seat 10D. Alternatively, in a case where a plurality of response sentences R are generated, the order of outputs of the plurality of response sentences R may freely be decided in accordance with a positional relationship among the seats 10 on which the occupants P are seated, the occupants P speaking the spoken sentences TXU as the targets of the responses by the response sentences R.

### 1-5. Details of Action of Response Generation Unit

Next, a description will be made about details of an action of the response generation unit 212 in step SB2.

The action in step SB2 is diverged into two patterns depending on whether or not the spoken sentence TXU as the text data, which is received in step SB1 in FIG. 3, is one spoken sentence TXU. Those patterns are determined by the response generation unit 212 based on the number of spoken sentences TXU which are received in step SB1.

Note that as described above, in the present embodiment, one input voice includes one spoken sentence TXU. Thus, it can be considered that the action in step SB2 is diverged into two patterns of a case where one input voice to the microphone 11 is recognized by the input voice recognition unit 113 and of a case where a plurality of input voices to the microphones 11 are recognized by the input voice recognition unit 113.

### 1-5-1. Action for One Spoken Sentence

In the following, a description will be made about the action in step SB2 in a case where one spoken sentence TXU is received in step SB1.

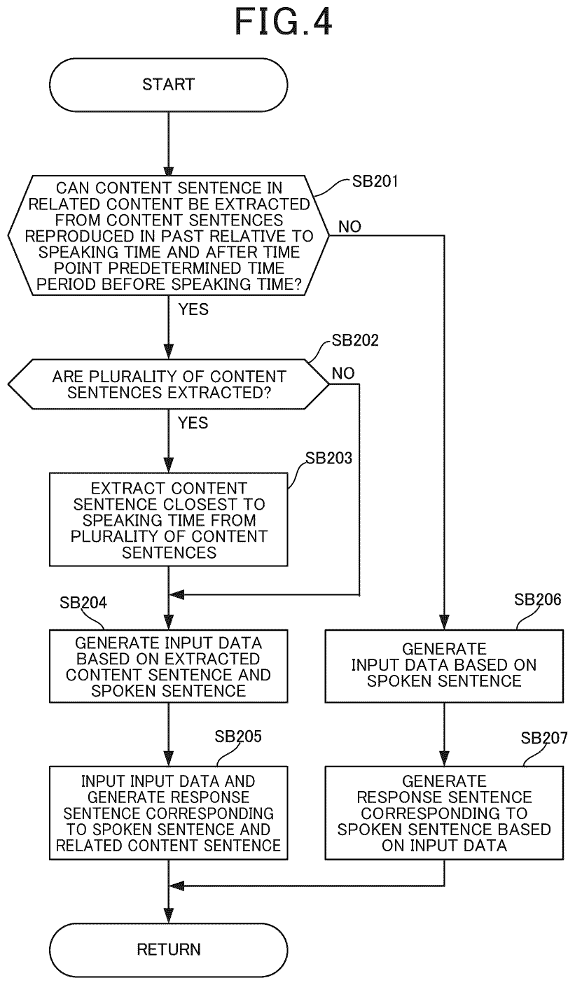

FIG. 4 is a flowchart illustrating the action of the response generation unit 212 and illustrates details of the action in step SB2 in a case where one spoken sentence TXU is received.

In the beginning of step SB2, in step SB201, the input data generation unit 214 determines whether or not the content sentence TXC included in a related content of the input voice can be extracted from all of the content sentences TXC which have been reproduced in the past relative to the speaking time of the spoken sentence TXU and after past time a predetermined time period before the speaking time. The related content of the input voice represents the content C, which is related to the input voice, among the contents C. That is, the content sentence TXC of the related content is related to the spoken sentence TXU included in the input voice. Note that the predetermined time period mentioned here is 30 seconds, for example.

In other words, in the present embodiment, the response generation unit 212 determines whether or not the content C is the related content of the input voice while setting the above content C as a target, the above content C being reproduced by the speaker 13 or the display 12 after a time point the predetermined time period before a time point when the input voice has been input to the microphone 11. Then, in a case where it is determined that the content C is the related content of the input voice, the response generation unit 212 determines whether or not the content sentence TXC can be extracted from the above content C.

Note that the fact that the spoken sentence TXU and the content sentence TXC are related to each other includes the fact that the spoken sentence TXU is a response to the content sentence TXC. The fact that the spoken sentence TXU is a response to the content sentence TXC includes the fact that the contents of the spoken sentence TXU are contents about a subject similar to a subject of the content sentence TXC, the fact that the contents of the spoken sentence TXU are an impression, a reaction such as an affirmation or a denial, or a reply on accepting the content sentence TXC, and so forth, for example.

In the present embodiment, in detail, the input data generation unit 214 executes a determination in step SB201 by the following process.

First, the input data generation unit 214 refers to the speaking time information DTU corresponding to the spoken sentence TXU and specifies the speaking time of the spoken sentence TXU. Next, the input data generation unit 214 extracts, by referring to the reproduction time information DTC, all of the content sentences TXC which have been reproduced in the past relative to the specified speaking time and after a time point a predetermined time period before the specified speaking time as a start point. The input data generation unit 214 determines whether or not the content sentence TXC related to the spoken sentence TXU can further be extracted from the above extracted content sentences TXC.

Note that differently from the present embodiment, the input data generation unit 214 may be configured to determine, in step SB201, whether or not the content C corresponding to the content sentences TXC is the related content while setting, as targets, the content sentences TXC in a predetermined position and subsequent positions in the order from the last position in a case where the speaker 13 and the display 12 have reproduced the content C including a plurality of content sentences TXC. The predetermined position in the order which is mentioned here is the fifth position, for example.

In this case, in detail, the input data generation unit 214 executes the determination in step SB201 by the following process.

First, the input data generation unit 214 refers to the speaking time information DTU corresponding to the spoken sentence TXU and specifies the speaking time of the spoken sentence TXU. Next, the input data generation unit 214 extracts, by referring to the reproduction time information DTC, all of the content sentences TXC which have been reproduced in the past relative to the specified speaking time. The input data generation unit 214 extracts the content sentences TXC, which are the content sentence TXC at late reproduction time to the content sentence TXC in a predetermined position in the order, from the above extracted content sentences TXC. Then, the input data generation unit 214 determines whether or not one or more content sentences TXC related to the spoken sentence TXU can be extracted from the extracted content sentences TXC to the predetermined position in the order.

Note that the input data generation unit 214 may determine whether or not the content sentence TXC and the spoken sentence TXU are related to each other by applying natural language processing to the content sentence TXC and the spoken sentence TXU. A learned model or the like which uses machine learning or the like may be used for natural language processing, for example.

Specifically, for example, the input data generation unit 214 vectorizes words included in the content sentence TXC and words included in the spoken sentence TXU by using any learned model. Then, when a combination is present in which cosine similarity between vectorized words exceeds a predetermined value, it may be determined that the content sentence TXC and the spoken sentence TXU are related to each other. Alternatively, by using any method, it may be determined whether or not the content sentence TXC and the spoken sentence TXU are related to each other.

In step SB201, in a case where the input data generation unit 214 determines that the content sentence TXC of the related content can be extracted (YES in step SB201), the action of the response generation unit 212 moves to step SB202.

In step SB202, the input data generation unit 214 determines whether or not there are a plurality of content sentences TXC, which are extracted in step SB201.

In step SB202, in a case where the input data generation unit 214 determines that there are the plurality of content sentences TXC, which are extracted in step SB201 (YES in step SB202), the action of the response generation unit 212 moves to step SB203.

In step SB202, in a case where the input data generation unit 214 determines that there is one content sentence TXC, which is extracted in step SB201 (NO in step SB202), the action of the response generation unit 212 moves to step SB204.

In step SB203, the input data generation unit 214 refers to the reproduction time information DTC and thereby extracts one content sentence TXC, whose reproduction time is closest to the speaking time of the spoken sentence TXU, from the plurality of content sentences TXC extracted in step SB201.

Next, in step SB204, the input data generation unit 214 generates the input data based on one content sentence TXC, which is extracted in step SB203 or SB204, and the spoken sentence TXU. The input data are the content sentence TXC and spoken sentence TXU as the text data, which have been converted into a form capable of being input to the response generation model 222, for example.

Next, in step SB205, the response sentence generation unit 213 inputs the input data, which are generated in step SB204, to the response generation model 222 and generates the response sentence R which corresponds to the spoken sentence TXU and the content sentence TXC. Subsequently, a process in step SB2 indicated in FIG. 4 is finished, and the action moves to step SB3 in FIG. 3.

That is, the response generation unit 212 generates the response sentence R to the input voice based on the input voice and the content C which has been reproduced by the speaker 13 or the display 12 before an input time point of the input voice to the microphone 11.

The response generation unit 212 determines whether or not the content C, which has been reproduced by the display 12 or the speaker 13 before the input time point of the input voice to the microphone 11, is the related content which is related to the spoken sentence TXU included in the input voice. Then, in a case where the content C reproduced by the display 12 or the speaker 13 is the related content, the response generation unit 212 generates the response sentence R based on the spoken sentence TXU included in the input voice and the content sentence TXC included in the related content.

In the present embodiment, in a case where the content C, which has been reproduced by the display 12 or the speaker 13 before the input time point of the input voice to the microphone 11, includes a plurality of content sentences TXC which are related to the spoken sentence TXU included in the input voice, the response generation unit 212 generates the response sentence R based on the spoken sentence TXU included in the input voice and the content sentence TXC, which has been reproduced by the display 12 or the speaker 13 at a time point closest to the input time point of the spoken sentence TXU included in the input voice, among the plurality of content sentences TXC.

In step SB201, when it is determined that the input data generation unit 214 determines that the content sentence TXC related to the spoken sentence TXU cannot be extracted (NO in step SB201), the action of the response generation unit 212 moves to step SB206.

In step SB206, the input data generation unit 214 generates the input data based on the spoken sentence TXU without using the content sentence TXC. The input data are the spoken sentence TXU as the text data, which has been converted into the form capable of being input to the response generation model 222, for example.

In step SB207, the response sentence generation unit 213 inputs the input data, which are generated in step SB206, to the response generation model 222 and generates the response sentence R which corresponds to the spoken sentence TXU. Subsequently, the process in step SB2 indicated in FIG. 4 is finished, and the action moves to step SB3 in FIG. 3.

That is, the response generation unit 212 determines whether or not the content C, which has been reproduced by the display 12 or the speaker 13 before the input time point of the input voice to the microphone 11, is the related content which is related to the spoken sentence TXU included in the input voice. Then, in a case where the content C reproduced by the display 12 or the speaker 13 is not the related content, the response generation unit 212 generates the response sentence R based on the spoken sentence TXU included in the input voice.

As in step SB201 to step SB207, the response generation unit 212 generates the response sentence R by using the spoken sentence TXU and the content sentence TXC included in the related content of the spoken sentence TXU as the input data for the response generation model 222. Thus, the response sentence R can be generated which is in consideration of contents of the content C in addition to contents of speech of the occupant P, and a natural response can be performed.

When the content sentence TXC included in the related content of the spoken sentence TXU is not present, the response sentence R is generated by using the spoken sentence TXU as the input data for the response generation model 222. Accordingly, when the contents of the speech of the occupant P are not related to the contents of the content C, the response sentence R can be generated without taking into consideration the contents of the content C, and a natural response can be performed.

### 1-5-2. Action for Plurality of Spoken Sentences

In the following, a description will be made about the action in step SB2 in a case where a plurality of spoken sentences TXU are received in step SB1.

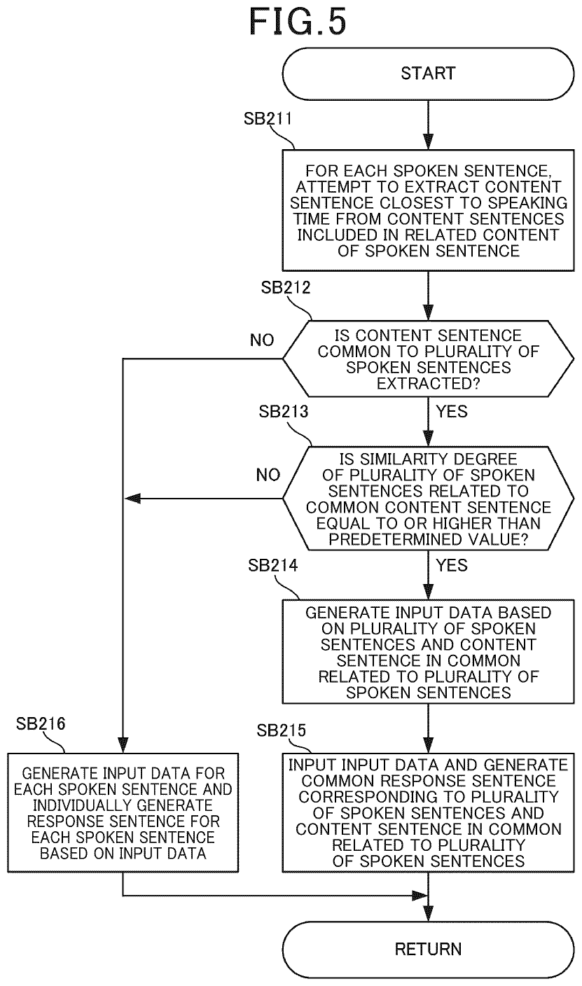

FIG. 5 is a flowchart illustrating the action of the response generation unit 212 and illustrates details of the action in step SB2 in a case where a plurality of spoken sentences TXU are received.

In the beginning of step SB2, in step SB211, the input data generation unit 214 attempts to extract, for each of the received spoken sentences TXU, the content sentences TXC included in the related contents about the above spoken sentence TXU from all of the content sentences TXC which have been reproduced in the past relative to the speaking time and after a time point a predetermined time period before the speaking time. In a case where a plurality of content sentences TXC are extracted for one spoken sentence TXU, the input data generation unit 214 extracts the content sentence TXC, whose reproduction time by the speaker 13 or the display 12 is closest to the speaking time of the above spoken sentence TXU, from the plurality of extracted content sentences TXC. The predetermined time period mentioned here is 30 seconds, for example. A detailed method of extraction is described in steps SB201 and SB203.

In step SB212, the input data generation unit 214 determines whether or not a common content sentence TXC, which corresponds to the plurality of spoken sentences TXU, is extracted in step SB211.

In step SB212, in a case where the input data generation unit 214 determines that the common content sentence TXC, which corresponds to the plurality of spoken sentences TXU, is extracted (YES in step SB212), the action of the response generation unit 212 moves to step SB213. As a case where such a determination is made, a case is raised where a plurality of occupants P speak the spoken sentences TXU as responses about one content sentence TXC included in the content C.

In step SB213, as a result of steps SB211 and SB212, the input data generation unit 214 determines whether or not the plurality of spoken sentences TXU determined to be related to the common content sentence TXC are similar to each other. In detail, in the present embodiment, in step SB213, the input data generation unit 214 calculates a similarity degree which indicates a degree that the plurality of spoken sentences TXU related to the common content sentence TXC are similar to each other. When the calculated similarity degree is equal to or higher than a predetermined value, it is determined that the plurality of spoken sentences TXU related to the common content sentence TXC are similar to each other. When the calculated similarity degree is lower than the predetermined value, it is determined that the plurality of spoken sentences TXU related to the common content sentence TXC are not similar to each other.

That is, in step SB213, the response generation unit 212 determines whether or not the similarity degree of a plurality of input voices is equal to or higher than the predetermined value.

The fact that the plurality of spoken sentences TXU are similar to each other means that meaning contents of the plurality of spoken sentences TXU are similar to or the same as each other. For example, when the plurality of spoken sentences TXU together indicate affirmative reactions to the contents represented by the content sentence TXC, when the plurality of spoken sentences TXU together indicate negative reactions, or the like, it can be considered that the plurality of spoken sentences TXU are similar to each other. Conversely, for example, when between two spoken sentences TXU, one indicates an affirmative reaction but the other indicates a negative reaction to the contents represented by the content sentence TXC, it can be considered that the plurality of spoken sentences TXU are not similar to each other.

In detail, the input data generation unit 214 may determine whether or not the plurality of spoken sentences TXU are similar to each other by using any learned model or the like which uses machine learning.

For example, the input data generation unit 214 may be configured to input the plurality of spoken sentences TXU to the learned model and to thereby obtain the similarity degree of the spoken sentences TXU.

In step SB213, in a case where the input data generation unit 214 determines that the similarity degree is equal to or higher than the predetermined value (YES in step SB213), the action of the response generation unit 212 moves to step SB214.

In step SB214, the input data generation unit 214 generates the input data for the response generation model 222 based on the plurality of spoken sentences TXU included in a plurality of input voices and the content sentence TXC included in the related content common to the plurality of spoken sentences TXU. The input data are the plurality of spoken sentences TXU and the content sentence TXC as the text data, which have been converted into the form capable of being input to the response generation model 222, for example.

Next, in step SB215, the response sentence generation unit 213 inputs the input data, which are generated in step SB214, to the response generation model 222 and generates a common response sentence R for the plurality of spoken sentences TXU and the content sentence TXC which are in common related to those. Subsequently, the process in step SB2 indicated in FIG. 5 is finished, and the action moves to step SB3 in FIG. 3.

That is, in the present embodiment, in a case where the similarity degree of the plurality of input voices is equal to or higher than the predetermined value, the response generation unit 212 generates the common response sentence R for the plurality of input voices based on the plurality of spoken sentences TXU included in the plurality of input voices and the content sentence TXC included in the content C.

In step SB212, in a case where the input data generation unit 214 determines that the common content sentence TXC, which corresponds to the plurality of spoken sentences TXU, is not extracted (NO in step SB212), the action of the response generation unit 212 moves to step SB216. As a case where such a determination is made, a case is raised where a plurality of occupants P respectively speak the spoken sentences TXU as responses about different content sentences TXC, for example.

Similarly, in step SB213, in a case where the input data generation unit 214 determines that the similarity degree is lower than the predetermined value (NO in step SB213), the action of the response generation unit 212 moves to step SB216. As a case where such a determination is made, a case is raised where a plurality of occupants P speak the spoken sentences TXU, which indicate different reactions, about the same content sentence TXC, for example.

In step SB216, the response generation unit 212 applies a process from step SB201 to step SB205 in FIG. 4 for each of the plurality of spoken sentences TXU. Then, for each of the spoken sentences TXU, the response generation unit 212 generates the response sentence R by using, as the input data, only the spoken sentence TXU or the spoken sentence TXU and the content sentence TXC related to this spoken sentence TXU. Subsequently, the process in step SB2 indicated in FIG. 5 is finished, and the action moves to step SB3 in FIG. 3.

That is, in the present embodiment, in a case where the similarity degree of the plurality of input voices is lower than the predetermined value, for each of the spoken sentences TXU included in the plurality of input voices, the response generation unit 212 individually generates the response sentence R based on the spoken sentence TXU included in each of the input voices and the content sentence TXC included in the content C.

As from step SB211 to step SB216, in a case where the plurality of spoken sentences TXU, which are each related to the common content sentence TXC and are similar to each other, are received, the response generation unit 212 generates the common response sentence R for the plurality of spoken sentences TXU. Thus, when a plurality of occupants P indicate similar reactions to the content C, the common response sentence R is output, and it thereby becomes easy to perform a natural response.

When the plurality of spoken sentences TXU are not related to the common content sentence TXC or are not similar to each other, the response generation unit 212 individually generates the response sentence R for each of the spoken sentences TXU. Thus, when the plurality of occupants P indicate different reactions to the content C, a different response sentence R can be output for each of the occupants P, and it thereby becomes easy to perform a natural response.

### 2. Other Embodiments

The above-described embodiment only represents one form, and any modifications and applications are possible.

In the present embodiment, the response system 1000 is configured to output the response sentence R to speech of the occupant P in an internal portion of the vehicle 1, but this is one example. For example, the response device 100 may be configured to be arranged in a room of a building and to output the response sentence R to speech of a person in the room while taking into consideration the content C reproduced in the room. Alternatively, the response system 1000 may be configured to output the response sentence R to speech of a person in any space.

Each of the first processor 110 and the second processor 210 may be configured with a plurality of processors or may be configured with a single processor. Each of the processors 110 and 210 may be hardware which is programmed to realize the above-described function units. In this case, those processors are configured with an application-specific integrated circuit (ASIC) and a field-programmable gate array (FPGA), for example.

A configuration of each unit of the response system 1000 illustrated in FIG. 2 is one example, and a specific mounting form is not particularly limited. In other words, hardware which individually corresponds to each unit does not necessarily have to be mounted, and it goes without saying that a configuration is possible in which one processor executes a program and thereby realizes a function of each unit. A part of a function which is realized with software in the above-described embodiment may be provided as hardware, or a part of a function which is realized with hardware may be realized with software.

Step units of the actions illustrated in FIG. 3 to FIG. 5 result from division corresponding to main processing contents, and the present invention is not limited by a manner or a name of division of a processing unit. Division into a larger number of step units may be performed in accordance with the processing contents. Division may be performed such that one step unit includes a larger number of processes. Order of the steps may appropriately be switched within the scope that does not interfere with the gist of the present invention.

### 3. Configurations Supported by Above Embodiments

The above embodiments support the following configurations.

### Configuration 1

A response system including: a content reproduction unit that reproduces a content; a microphone; an input voice recognition unit that recognizes an input voice to the microphone; and a response generation unit that generates a response sentence to the input voice based on the input voice and the content which is reproduced by the content reproduction unit before an input time point of the input voice to the microphone.

The response system of the configuration 1 can generate the response sentence to the input voice while taking into consideration the content reproduced by the content reproduction unit. Thus, a natural response can be performed to the input voice.

### Configuration 2

The response system described in the configuration 1, in which the response generation unit determines whether or not the content which is reproduced by the content reproduction unit before the input time point of the input voice to the microphone is a related content which is related to the input voice and generates the response sentence based on the input voice and the related content in a case where the content reproduced by the content reproduction unit is the related content.

The response system of the configuration 2 can generate the response sentence to the input voice while taking into consideration the content when the input voice is related to the content reproduced by the content reproduction unit. Thus, a natural response can be performed to the input voice.

### Configuration 3

The response system described in the configuration 1 or 2, in which the response generation unit determines whether or not the content is the related content while setting, as a target, a content which is reproduced by the content reproduction unit after a time point a predetermined time period before a time point at which the input voice is input to the microphone or while setting, as targets, sentences in a predetermined position and subsequent positions in order from a last position in a case where the content reproduction unit reproduces the content including a plurality of sentences.

The response system of the configuration 3 can determine whether contents of the content, which is reproduced at a timing close to a timing at which the input voice is input, are related to the input voice and can generate the response sentence to the input voice. Thus, a natural response can be performed to the input voice.

### Configuration 4

The response system described in any one of the configurations 1 to 3, in which the response generation unit determines whether or not the content which is reproduced by the content reproduction unit before the input time point of the input voice to the microphone is a related content which is related to the input voice and generates the response sentence based on the input voice in a case where the content reproduced by the content reproduction unit is not the related content.

The response system of the configuration 4 can generate the response sentence to the input voice while not taking into consideration the content when the input voice is not related to the content reproduced by the content reproduction unit. Thus, a natural response can be performed to the input voice.

### Configuration 5

The response system described in any one of the configurations 1 to 4, in which the response generation unit generates the response sentence based on the input voice and a sentence, which is reproduced by the content reproduction unit at a time point closest to the input time point of the input voice, among a plurality of sentences in a case where the content, which is reproduced by the content reproduction unit before the input time point of the input voice to the microphone, includes the plurality of sentences which are related to the input voice.

The response system of the configuration 5 can determine whether contents of the content, which is reproduced at a timing close to a timing at which the input voice is input, are related to the input voice and can generate the response sentence to the input voice. Thus, a natural response can be performed to the input voice.

### Configuration 6

The response system described in any one of the configurations 1 to 5, in which in a case where a plurality of the input voices to the microphone are recognized by the input voice recognition unit, the response generation unit generates the response sentence common to the plurality of input voices based on the plurality of input voices and the content in a case where a similarity degree of the plurality of input voices is equal to or higher than a predetermined value and individually generates the response sentence for each of the plurality of input voices based on the input voice and the content in a case where the similarity degree of the plurality of input voices is lower than the predetermined value.

In the response system of the configuration 6, when a plurality of sentences of the input voices are similar, a common response sentence can be generated for the plurality of sentences, and when the plurality of sentences of the input voices are not similar, the response sentence can be generated for each of the plurality of sentences. Thus, a natural response can be performed to the input voice.

### Configuration 7

A response method including: reproducing a content by a content reproduction unit; recognizing an input voice to a microphone by an input voice recognition unit; and generating, by a response generation unit, a response sentence to the input voice based on the input voice and the content which is reproduced by the content reproduction unit before an input time point of the input voice to the microphone.

The response method of the configuration 7 can generate the response sentence to the input voice while taking into consideration the content reproduced by the content reproduction unit. Thus, a natural response can be performed to the input voice.

### REFERENCE SIGNS LIST

1 vehicle
10 seat
10A driver seat
10B passenger seat
10C rear right seat
10D rear left seat
11 microphone
11A driver seat microphone (microphone)
11B passenger seat microphone (microphone)
11C rear right seat microphone (microphone)
11D rear left seat microphone (microphone)
12 display (content reproduction unit)
12A center display (content reproduction unit)
12B passenger seat display (content reproduction unit)
12C rear right seat display (content reproduction unit)
12D rear left seat display (content reproduction unit)
13 speaker (content reproduction unit)
13A center speaker (content reproduction unit)
13B passenger seat speaker (content reproduction unit)
13C rear right seat speaker (content reproduction unit)
13D rear left seat speaker (content reproduction unit)
100 response device
110 first processor
111 first communication control unit
112 input-output control unit
113 input voice recognition unit
114 content recognition unit
120 first memory
121 first control program
122 content data
130 first communication unit
200 response generation server
210 second processor
211 second communication control unit
212 response generation unit
213 response sentence generation unit
214 input data generation unit
220 second memory
221 second control program
222 response generation model
230 second communication unit
300 content distribution server
1000 response system
C content
DTC reproduction time information
DTU speaking time information
DUC reproduction time information
IFP speaking person information
NW communication network
P, P1 to P4 occupant
R response sentence
TXC content sentence
TXU spoken sentence

What is claimed is:

1. A response system comprising:
a content reproduction unit that reproduces a content;
a microphone;
an input voice recognition unit that recognizes an input voice to the microphone; and
a response generation unit that generates a response sentence to the input voice based on the input voice and the content which is reproduced by the content reproduction unit before an input time point of the input voice to the microphone.

2. The response system according to claim 1, wherein
the response generation unit
determines whether or not the content which is reproduced by the content reproduction unit before the input time point of the input voice to the microphone is a related content which is related to the input voice and generates the response sentence based on the input voice and the related content in a case where the content reproduced by the content reproduction unit is the related content.

3. The response system according to claim 2, wherein
the response generation unit
determines whether or not the content is the related content while setting, as a target, a content which is reproduced by the content reproduction unit after a time point a predetermined time period before a time point at which the input voice is input to the microphone or while setting, as targets, sentences in a predetermined position and subsequent positions in order from a last position in a case where the content reproduction unit reproduces the content including a plurality of sentences.

4. The response system according to claim 1, wherein
the response generation unit
determines whether or not the content which is reproduced by the content reproduction unit before the input time point of the input voice to the microphone is a related content which is related to the input voice and generates the response sentence based on the input voice in a case where the content reproduced by the content reproduction unit is not the related content.

5. The response system according to claim 2, wherein
the response generation unit
generates the response sentence based on the input voice and a sentence, which is reproduced by the content reproduction unit at a time point closest to the input time point of the input voice, among a plurality of sentences in a case where the content, which is reproduced by the content reproduction unit before the input time point of the input voice to the microphone, includes the plurality of sentences which are related to the input voice.

6. The response system according to claim 2, wherein
in a case where a plurality of the input voices to the microphone are recognized by the input voice recognition unit,
the response generation unit
generates the response sentence common to the plurality of input voices based on the plurality of input voices and the content in a case where a similarity degree of the plurality of input voices is equal to or higher than a predetermined value and
individually generates the response sentence for each of the plurality of input voices based on the input voice and the content in a case where the similarity degree of the plurality of input voices is lower than the predetermined value.

7. A response method comprising:
reproducing a content by a content reproduction unit;
recognizing an input voice to a microphone by an input voice recognition unit; and
generating, by a response generation unit, a response sentence to the input voice based on the input voice and the content which is reproduced by the content reproduction unit before an input time point of the input voice to the microphone.
